(19) United States
(12) Patent Application Publication
(10) Pub. No.: US 2025/0014835 A1
(43) Pub. Date: Jan. 9, 2025

(54) COMPOSITE POWDER FOR MANUFACTURING POROUS BODY INCLUDED IN ANODE BODY OF ELECTROLYTIC CAPACITOR, METHOD OF MANUFACTURING COMPOSITE POWDER, AND METHOD OF MANUFACTURING ANODE BODY FOR ELECTROLYTIC CAPACITOR

(71) Applicant: Panasonic Intellectual Property Management Co., Ltd., Osaka (JP)

(72) Inventors: MASAYUKI HOGIRI, Osaka (JP); YUKIYASU SUGIHARA, Aichi (JP)

(21) Appl. No.: 18/743,467

(22) Filed: Jun. 14, 2024

(30) Foreign Application Priority Data
Jul. 6, 2023 (JP) 2023-111402

(51) Int. Cl. H01G 9/042; H01G 9/00

(52) U.S. Cl. CPC H01G 9/042; H01G 9/0029

(57) ABSTRACT

A composite powder for manufacturing a porous body included in an anode body of an electrolytic capacitor includes a raw material powder containing a valve metal and an aliphatic carboxylic acid compound adhering to surfaces of particles of the raw material powder, the aliphatic carboxylic acid compound excluding stearic acid, palmitic acid, and a polymer. A melting point of the aliphatic carboxylic acid compound is more than or equal to 35° C.

### BACKGROUND

### 1. Technical Field

The present disclosure relates to a composite powder for manufacturing a porous body included in an anode body of an electrolytic capacitor, a method of manufacturing the composite powder, and a method of manufacturing an anode body for an electrolytic capacitor.

### 2. Description of the Related Art

In recent years, an electrolytic capacitor that has a small equivalent series resistance (ESR) and excellent frequency characteristics has been developed. An anode body of the electrolytic capacitor includes, for example, a porous body containing a valve metal, and a dielectric layer covering the porous body. As a raw material of the porous body, for example, a raw material powder which contains the valve metal and to which an additive (binder) is added is used.

Unexamined Japanese Patent Publication No. 2022-533161 proposes “a solid electrolytic capacitor including a capacitor element that includes: a sintered porous anode body; a dielectric that overlies the anode body; and a solid electrolyte that overlies the dielectric and includes a conductive polymer and a depolarizer”. In addition, in Unexamined Japanese Patent Publication No. 2022-533161, a powder containing tantalum or the like is exemplified as a powder for forming the sintered porous anode body. In Unexamined Japanese Patent Publication No. 2022-533161, sodium polyacrylate, stearic acid, and the like are given as specific examples of the binder used for aggregation of particles of the powder.

Unexamined Japanese Patent Publication No. 2020-500260 proposes “a tantalum powder including tantalum, hydrogen doped in the tantalum, and nitrogen doped in the tantalum, wherein a value (H/BET) of a hydrogen (H) content (ppm) of the tantalum powder divided by Brunauer-Emmett-Teller (BET) surface area (m²/g) of the tantalum powder is greater than 100, wherein the tantalum powder has (a) a hydrogen content of from 300 ppm to 1200 ppm, (b) a nitrogen content of from 500 ppm to 3,500 ppm, and (c) a BET range of from 3 m²/g to about 10 m²/g”. In addition, in Unexamined Japanese Patent Publication No. 2020-500260, camphor, stearic acid, and the like are given as specific examples of the binder added to the tantalum powder.

Unexamined Japanese Patent Publication No. 2003-509583 proposes “a method of producing an anode for an electrolytic capacitor, the method including the steps of: combining a metal powder and dimethyl sulfone in an amount to be effective as a binder; pressing the powder and the dimethyl sulfone to form an anode body; and removing the dimethyl sulfone”.

Unexamined Japanese Patent Publication No. 2013-135211 proposes “a sintering method for a tantalum capacitor anode block, the sintering method including: inserting a tantalum anode block, molded from a tantalum powder mixed with an adhesive, into a drying oven, into which a degreasing solvent is injected; conducting hermetically low temperature solvent catalytic wet dewaxing; conducting vacuum drying; and conducting vacuum sintering”. In Unexamined Japanese Patent Publication No. 2013-135211, camphor, benzoic acid, stearic acid, and the like are given as specific examples of the adhesive.

Unexamined Japanese Patent Publication No. 2007-273710 proposes “a method of manufacturing an element for a solid electrolytic capacitor, the method including: compression-molding a valve metal powder containing a binder to obtain a compact element; and sintering the compact element in vacuum, wherein the compact element is immersed in pure water to apply ultrasonic vibration”. In Unexamined Japanese Patent Publication No. 2007-273710, stearic acid, palmitic acid, and benzoic acid are given as specific examples of the binder.

### SUMMARY

One aspect of the present disclosure relates to a composite powder for manufacturing a porous body included in an anode body of an electrolytic capacitor. The composite powder includes: a raw material powder containing a valve metal; and an aliphatic carboxylic acid compound adhering to a surface of a particle of the raw material powder, the aliphatic carboxylic acid compound excluding stearic acid, palmitic acid, and a polymer. A melting point of the aliphatic carboxylic acid compound is more than or equal to 35° C.

Another aspect of the present disclosure relates to a method of manufacturing a composite powder for manufacturing a porous body included in an anode body of an electrolytic capacitor. The method includes: a step of preparing a raw material powder containing a valve metal; a step of preparing a carboxylic acid solution containing a solvent and an aliphatic carboxylic acid compound having a melting point of more than or equal to 35° C., the aliphatic carboxylic acid compound excluding stearic acid, palmitic acid, and a polymer; a step of adding the carboxylic acid solution to the raw material powder while stirring the raw material powder to obtain the raw material powder in a wet state; and a step of removing the solvent by drying the raw material powder in the wet state while stirring the raw material powder to obtain a composite powder.

Still another aspect of the present disclosure relates to a method of manufacturing an anode body for an electrolytic capacitor. The method includes: a step of preparing a composite powder containing a raw material powder containing a valve metal and an aliphatic carboxylic acid compound adhering to a surface of a particle of the raw material powder, the aliphatic carboxylic acid compound excluding stearic acid, palmitic acid, and a polymer; a step of performing compression-molding after filling a predetermined mold with the composite powder to obtain a compact; a step of removing the aliphatic carboxylic acid compound included in the compact; a step of sintering the compact from which the aliphatic carboxylic acid compound has been removed to obtain a porous body; and a step of forming a dielectric layer on a surface of the porous body to obtain an anode body. A melting point of the aliphatic carboxylic acid compound is more than or equal to 35° C.

According to the present disclosure, regarding the porous body included in the anode body of the electrolytic capacitor, it is possible to reduce a content of carbon derived from an additive added to the raw material powder containing the valve metal in a process of producing the porous body, and reduce variation in mass.

### BRIEF DESCRIPTION OF THE DRAWINGS

FIG. 1 is a view illustrating an example of wet mixing of a raw material powder and aliphatic carboxylic acid compound A;

FIG. 2A is a view illustrating a state of a composite powder at the time of weighing in a process of producing a compact from the composite powder;

FIG. 2B is a view illustrating a state of the composite powder before compression-molding in the process of producing the compact from the composite powder;

FIG. 2C is a view illustrating a state of the composite powder at the time of compression-molding in the process of producing the compact from the composite powder;

FIG. 3 is a configuration diagram illustrating an example of equipment used in a step of removing aliphatic carboxylic acid compound A and a step of sintering a compact;

FIG. 4 is a cross-sectional view schematically illustrating an electrolytic capacitor according to an exemplary embodiment of the present disclosure; and

FIG. 5 is a cross-sectional view illustrating a state in which an evaluation jig set for weighing stability is filled with a powder.

### DETAILED DESCRIPTIONS OF EMBODIMENTS

Prior to the description of exemplary embodiments of the present disclosure, problems to be solved by the present disclosure are briefly described.

Regarding a porous body included in an anode body of an electrolytic capacitor, there is a demand for reducing a content of carbon derived from an additive added to a raw material powder containing a valve metal in a process of producing the porous body, and reducing variation in mass.

Hereinafter, the exemplary embodiments of the present disclosure will be described with reference to examples, but the present disclosure is not limited to examples to be described below. Although specific numerical values and materials are sometimes provided as examples in the following description, other numerical values and materials may be used as long as the effect of the present disclosure can be achieved. In this specification, the description “from numerical value A to numerical value B” includes a numerical value A and a numerical value B, and can be read as “between numerical value A and numerical value B (inclusive)”. In the following description, in a case where lower limits and upper limits related to numerical values of specific physical properties, conditions, or the like are illustrated, any of the illustrated lower limits and any of the illustrated upper limits can be freely combined unless the lower limit is more than or equal to the upper limit. In a case where a plurality of materials is illustrated, one of the materials may be selected and used alone, or two or more of the materials may be used in combination.

The anode body of the electrolytic capacitor includes a porous body (porous sintered body) containing a valve metal, and a dielectric layer covering a surface of the porous body. The present disclosure relates to a composite powder for manufacturing the porous body included in the anode body of the electrolytic capacitor. A composite powder according to an exemplary embodiment of the present disclosure contains a raw material powder containing a valve metal and an aliphatic carboxylic acid compound (excluding stearic acid, palmitic acid, and a polymer) attached to surfaces of particles of the raw material powder. A melting point of the aliphatic carboxylic acid compound is more than or equal to 35° C.

Hereinafter, the aliphatic carboxylic acid compound (excluding stearic acid, palmitic acid, and a polymer) having the melting point of more than or equal to 35° C. is also referred to as “aliphatic carboxylic acid compound A”. The particles of the raw material powder are also referred to as “raw material particles”. Particles of the composite powder include the raw material particles and aliphatic carboxylic acid compound A attached to the surfaces of the raw material particles. Hereinafter, the particles of the composite powder are also referred to as “composite particles”.

In the composite powder obtained by adding aliphatic carboxylic acid compound A as an additive to the raw material powder, higher weighing stability (fluidity) can be achieved. This makes it possible to reduce variation in mass of a compact and the porous body (anode body). Furthermore, in a case where a small amount of aliphatic carboxylic acid compound A is added, sufficiently high weighing stability can be achieved, a content of carbon derived from the additive of the porous body can be reduced, and an increase in leakage current when the content of carbon is large can be suppressed.

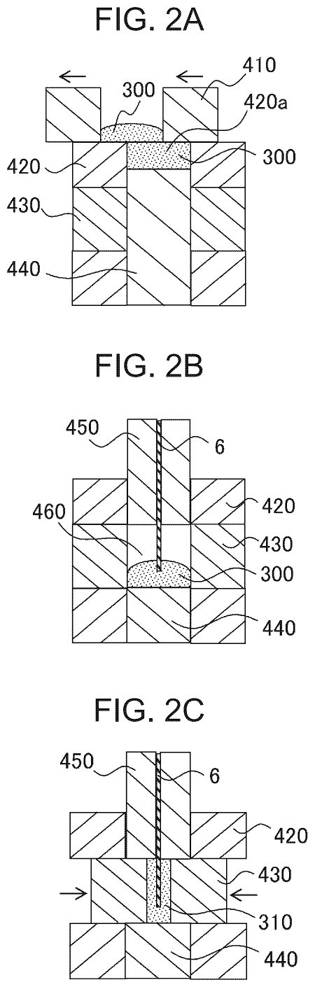

Note that high weighing stability of the powder means that variation in an amount of the powder filled in a weighing hole is small when the powder is weighed by filling the weighing hole of a weighing jig with the powder using a grinding jig. The powder is weighed by, for example, filling weighing hole 420a with powder 300 in FIG. 2A.

In a case where the variation in mass of the porous body is large, variation in surface area of the porous body (anode body) becomes large, which may increase variation in capacitance of the electrolytic capacitor. In the above case, when a plurality of porous bodies is collectively subjected to an anodizing treatment at the same anodizing voltage, variation in anodizing current between the porous bodies increases, and variation in film quality of an anodization film thus formed increases, which may increase variation in leakage current (LC) of the electrolytic capacitor. As described above, variation in characteristics of the electrolytic capacitor may increase. As a method of reducing the variation in characteristics of the electrolytic capacitor, it is conceivable to take away a compact out of a predetermined mass range as a defective product in a stage where the compact is obtained, but in the above case, a molding defect rate increases, which is disadvantageous in terms of productivity.

### (Raw Material Powder)

The raw material powder contains the valve metal. Examples of the valve metal include aluminum (Al), titanium (Ti), tantalum (Ta), niobium (Nb), zirconium (Zr), and hafnium (Hf). The raw material particles may be particles of the valve metal, particles of an alloy containing the valve metal, or particles of a compound containing the valve metal. Only one of these kinds of particles may be used, or two or more thereof may be used in mixture.

An average particle size of the raw material powder may be 100 μm or less or 80 μm or less. In this case, it is possible to suppress an increase in density variation of a compact due to partially uneven distribution of coarse particles in the compact, and dimensional variation of the compact can also be reduced by improving flatness of a surface of the compact. In addition, it is relatively difficult to set an average particle size to 100 μm or more with a powder having a coefficient of variation (CV) value of 100 FV/g (100 kCV) or more, and thus, there is also an advantage that options for selecting the raw material powder increase. The higher weighing stability of the raw material powder having an average particle size of 100 μm or less can be achieved by adding aliphatic carboxylic acid compound A. If camphor is added to the raw material powder having the average particle size of 100 μm or less, the weighing stability of the powder may be deteriorated.

In addition, the average particle size of the raw material powder may be 10 μm or more from the viewpoint that the powder can be suppressed from soaring to the atmosphere. In this case, it is possible to suppress a decrease of the powder due to soaring of the powder to the atmosphere when the powder is transferred from a container to another container, and it is also possible to mitigate a risk that a worker inhales the powder. Further, it is also possible to suppress dissipation of particles from a gap of a molded member due to a small particle size.

Note that the average particle size referred to herein is a median diameter (D50) in a volume-based particle size distribution obtained with a laser diffraction particle size distribution analyzer.

### (Aliphatic Carboxylic Acid Compound A)

A melting point of aliphatic carboxylic acid compound A is more than or equal to 35° C., and is stably in a solid state at the room temperature (about from 20° C. to 25° C.). Therefore, the composite powder can be obtained as a powder in a dry state, and excellent fluidity can be secured. The melting point of aliphatic carboxylic acid compound A may be more than or equal to 40° C., or may be more than or equal to 45° C.

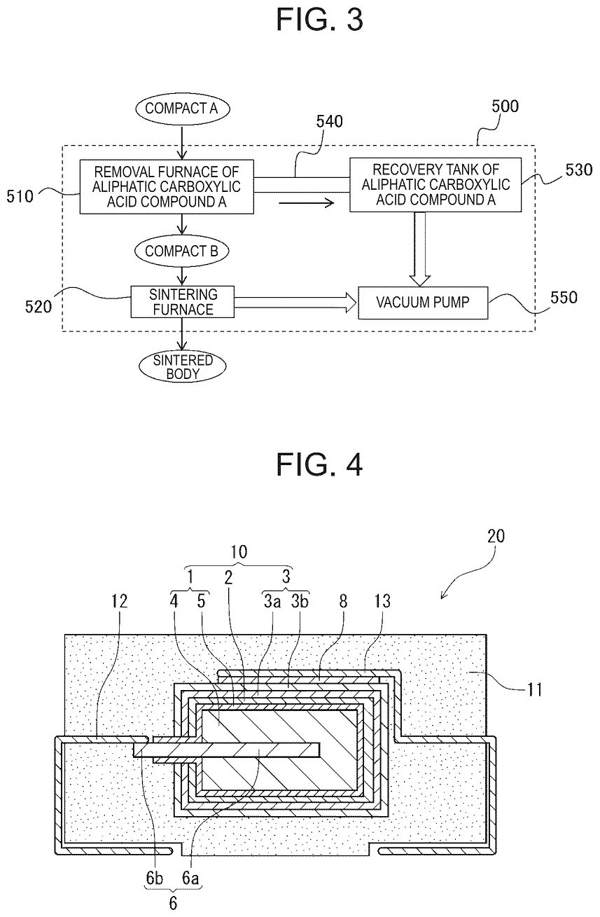

From the viewpoint of productivity in a step of removing aliphatic carboxylic acid compound A, which will be described later, the melting point of aliphatic carboxylic acid compound A is preferably less than or equal to 120° C., more preferably less than or equal to 100° C., still more preferably less than or equal to 90° C., and particularly preferably less than or equal to 80° C. When the melting point of aliphatic carboxylic acid compound A is within the above range, it is possible to prevent aliphatic carboxylic acid compound A from being fixed to an inner wall of a pipe (heat insulation pipe 540 in FIG. 3) from a removal furnace of aliphatic carboxylic acid compound A to a recovery tank by keeping the pipe at a temperature about from 120° C. to 150° C. in the step of removing aliphatic carboxylic acid compound A using equipment of FIG. 3. In addition, it is not necessary to dispose a pipe having a heat resistant structure or to add equipment for raising the temperature of the pipe to more than or equal to 150° C., which is advantageous in terms of cost.

If an additive is benzoic acid (melting point: 122.4° C.) and the temperature of the above-described pipe is in a range about from 120° C. to 150° C., benzoic acid may be precipitated in the pipe (or near the pipe in the removal furnace).

A boiling point of aliphatic carboxylic acid compound A is preferably less than or equal to 400° C. In the step of removing aliphatic carboxylic acid compound A, aliphatic carboxylic acid compound A can be removed by evaporation at a temperature from 400° C. to 500° C. Such a temperature range is substantially the same as a temperature range in which camphor is removed by evaporation and a temperature range in which an acrylic resin is removed by thermal decomposition and evaporation, and equipment for used of the camphor or the acrylic resin as the additive can be used as it is.

Aliphatic carboxylic acid compound A does not contain a polymer. Examples of the polymer include polyacrylic acid and Na salt thereof. In the case of the polymer, an amount added to the raw material powder for improvement of the weighing stability increases, and the carbon content of the porous body may increase. When the composite powder is obtained using the polymer, an agglomerate (for example, 300 μm or more) of particles that firmly adhere by the polymer is likely to be formed after a step of removing a solvent. The agglomerate is likely to cause a problem that variation in filling of the weighing hole with powder increases, that a locally dense portion is formed inside the compact, or that a sintered body having an irregular shape is formed. Therefore, it is necessary to separately provide a step of removing the agglomerate, which leads to a loss of the powder and is disadvantageous in terms of productivity.

In addition, polyacrylic acid is not preferable from the viewpoint of harmfulness to a human body and the like. Further, regarding Na salt thereof, Na is mixed into the porous body as a metal impurity, and there is a possibility of causing a decrease in reliability such as an increase in LC, which is not preferable.

Aliphatic carboxylic acid compound A does not contain stearic acid and palmitic acid. Stearic acid is hardly dissolved in a solvent (for example, ethanol to be described later), and it takes time for the dissolution. In addition, due to a low degree of solubility, stearic acid is precipitated due to slight evaporation of the solvent so that mixing unevenness is likely to occur when the raw material powder and a liquid containing stearic acid are mixed, which is not suitable for wet mixing with the raw material powder. The same applies to palmitic acid.

The number of carbon atoms of aliphatic carboxylic acid compound A is, for example, 12 or more in the case of a saturated fatty acid, and is, for example, 3 or more in the case of an unsaturated fatty acid. One kind of aliphatic carboxylic acid compound A may be used alone, or two or more kinds thereof may be used in combination.

Aliphatic carboxylic acid compound A may be a saturated fatty acid. Examples of the saturated fatty acid include lauric acid, tridecylic acid, myristic acid, pentadecylic acid, and the like. These compounds have a large degree of solubility of more than or equal to 20 g in 100 g of ethanol or the like, which will be described later, a melting point in the range from 35° C. to 100° C., and a boiling point of less than or equal to 400° C.

Aliphatic carboxylic acid compound A may be an unsaturated fatty acid. Examples of the unsaturated fatty acid include crotonic acid, elaidic acid, bacenic acid, nervonic acid, eleostearic acid, and the like. These compounds are easily dissolved in ethanol or the like, which will be described later, and have a melting point in the range from 35° C. to 120° C. and a boiling point of less than or equal to 400° C.

Aliphatic carboxylic acid compound A may be a monocarboxylic acid or a dicarboxylic acid. Examples of the monocarboxylic acid include those exemplified above. Examples of the dicarboxylic acid include glutaric acid and the like. Glutaric acid is easily dissolved in ethanol or the like, which will be described later, and has a melting point in the range from 35° C. to 120° C. and a boiling point of less than or equal to 400° C.

A content of aliphatic carboxylic acid compound A in the composite powder is preferably more than or equal to 0.002 parts by mass and less than or equal to 0.1 parts by mass with respect to 100 parts by mass of the raw material powder. When the content of aliphatic carboxylic acid compound A is less than or equal to 0.1 parts by mass, the carbon content of the porous body is sufficiently reduced, and the leakage current is sufficiently reduced. In addition, the strength of the compact is sufficiently secured. When the content of aliphatic carboxylic acid compound A is more than or equal to 0.002 parts by mass, the weighing stability of the composite powder is easily improved. The content of aliphatic carboxylic acid compound A is more preferably more than or equal to 0.002 parts by mass and less than or equal to 0.05 parts by mass from the viewpoint of further reducing the carbon content of the porous body. The content of aliphatic carboxylic acid compound A is more preferably more than or equal to 0.005 parts by mass and less than or equal to 0.1 parts by mass from the viewpoint of further improving the weighing stability of the powder. The content of aliphatic carboxylic acid compound A is particularly preferably more than or equal to 0.005 parts by mass and less than or equal to 0.05 parts by mass.

If the additive is an acrylic polymer, the carbon content of the porous body may increase, and the leakage current (LC) may increase. Although the detailed reason is unknown, it is presumed that it is necessary to add a large amount of the acrylic polymer (for example, add more than or equal to 1 part by mass of the acrylic polymer to 100 parts by mass of the raw material powder) in order to improve the weighing stability, and some thermal decomposition products generated by thermal decomposition in a step of removing the additive are likely to remain without being removed by evaporation. Examples of the acrylic polymer include poly(meth)acrylic acid and salt thereof, (meth)acrylic acid ester polymer (acrylic resin), and the like. The “(meth)acrylic acid” means at least one selected from the group consisting of “acrylic acid” and “methacrylic acid”.

The content (amount with respect to 100 parts by mass of the raw material powder) of the additive (aliphatic carboxylic acid compound A) in the composite powder can be obtained as follows. The composite powder is put into an organic solvent such as ethanol, stirred, and then separated into a raw material powder (for example, Ta powder) and a liquid (carboxylic acid solution) by filtration, centrifugation, or the like. The liquid is dried to obtain a precipitate (additive). The mass of the raw material powder and the mass of the precipitate are measured, and a ratio (percentage) of the mass of the precipitate to the mass of the raw material powder is obtained.

A component of the additive can be obtained, for example, by gas chromatography mass spectrometry. Further, the melting point and the boiling point described above are measured by a general method described in, for example, Japanese Industrial Standards (JIS). The melting point may be measured by differential scanning calorimetry (DSC) as necessary. The boiling point may be measured by thermogravimetric differential thermal analysis (TG/DTA) as necessary.

### [Method of Manufacturing Composite Powder]

A method of manufacturing a composite powder according to an exemplary embodiment of the present disclosure includes: a step of preparing a raw material powder containing a valve metal; a step of preparing a solution of aliphatic carboxylic acid compound A (hereinafter, also referred to as “carboxylic acid solution A”); a step of mixing the raw material powder and carboxylic acid solution A; and a step of removing a solvent.

When a small amount (for example, less than or equal to 0.1 parts by mass) of aliphatic carboxylic acid compound A is added to 100 parts by mass of the raw material powder, a homogeneous composite powder can be produced from the raw material powder in a wet state which is obtained by mixing aliphatic carboxylic acid compound A in a state of being dissolved in a solvent with the raw material powder (by wet mixing). If a small amount of aliphatic carboxylic acid compound A and the raw material powder are dry-mixed at a temperature more than or equal to the melting point of aliphatic carboxylic acid compound A, it is difficult to spread a small amount of melted aliphatic carboxylic acid compound A over the entire surface of the raw material powder, and it is difficult to produce the homogeneous composite powder. In addition, in this method, melted aliphatic carboxylic acid compound A is likely to adhere to a wall surface of a mixing container, and a proportion of the aliphatic carboxylic acid compound A which does not contribute to make the composite powder may increase, and it is difficult to adjust an addition amount of aliphatic carboxylic acid compound A with respect to the raw material powder.

### (Step of Preparing Raw Material Powder)

As the raw material powder, those exemplified above can be used.

### (Step of Preparing Carboxylic Acid Solution A)

Carboxylic acid solution A contains aliphatic carboxylic acid compound A and a solvent. As aliphatic carboxylic acid compound A, those exemplified above can be used. The concentration of aliphatic carboxylic acid compound A in the carboxylic acid solution ranges, for example, from 0.01% by mass to 2% by mass, inclusive. The concentration of aliphatic carboxylic acid compound A in the carboxylic acid solution can be obtained from a content of aliphatic carboxylic acid compound A in a composite powder and an addition amount of carboxylic acid solution A in a manufacturing process. When it is necessary to lower the concentration of carboxylic acid solution A, first, the concentration may be lowered by first producing high-concentration carboxylic acid solution A, and then, diluting the solution with the solvent. For example, 0.1% by mass carboxylic acid solution A may be produced, and then, 1% by mass carboxylic acid solution A and the solvent may be mixed at a mass ratio of 1:9 to produce 0.1% by mass carboxylic acid solution A.

The solvent is not a highly harmful solvent such as toluene, but is preferably a solvent having relatively low harmfulness. Examples of the solvent having relatively low harmfulness include ethanol, isopropanol, and butyl acetate (hereinafter, also referred to as “ethanol or the like”). One type of the solvent may be used singly, or two or more types may be used in combination.

The solvent is ethanol, isopropanol, or butyl acetate, and a degree of solubility of aliphatic carboxylic acid compound A in 100 g of the solvent at 20° C. is preferably more than or equal to 20 g. It is preferable that at least one solvent among the three solvents satisfies the degree of solubility in the above range. In this case, a dissolution rate of aliphatic carboxylic acid compound A in the solvent is high, and carboxylic acid solution A can be easily produced. In this case, the occurrence of mixing unevenness is sufficiently suppressed, and it is easy to homogeneously mix the raw material particles and aliphatic carboxylic acid compound A.

If the degree of solubility of the additive in the solvent is low, a long time is required at the time of preparing an additive solution, the solvent volatilizes at the time of mixing the additive solution and the raw material powder, a part of the additive is precipitated on a wall surface of a mixing container, so that the mixing unevenness may occur. If the additive is stearic acid, stearic acid has a low degree of solubility in ethanol or the like, a long time is required to prepare a stearic acid solution using ethanol or the like, and a white solid substance is likely to adhere to the wall surface of the mixing container at the time of mixing the stearic acid solution and the raw material powder, and the mixing unevenness is likely to occur. The same applies when the additive is palmitic acid.

### (Step of Mixing Raw Material Powder and Carboxylic Acid Solution A)

This step is a step of wet-mixing the raw material powder and aliphatic carboxylic acid compound A. That is, in the mixing step, the carboxylic acid solution is added to the raw material powder while stirring the raw material powder to obtain the raw material powder in the wet state.

The addition amount of aliphatic carboxylic acid compound A is preferably more than or equal to 0.002 parts by mass and less than or equal to 0.1 parts by mass with respect to 100 parts by mass of the raw material powder. When the addition amount of aliphatic carboxylic acid compound A is less than or equal to 0.1 parts by mass, the carbon content of the porous body is sufficiently reduced, the strength of the compact is sufficiently secured, and the occurrence of a crack or a partial chipping in a sintered body due to a decrease in the strength is sufficiently suppressed. When the addition amount of aliphatic carboxylic acid compound A is more than or equal to 0.002 parts by mass, it is easy to obtain a composite powder excellent in weighing stability.

The addition amount of carboxylic acid solution A is preferably more than or equal to 5 parts by mass and less than or equal to 20 parts by mass with respect to 100 parts by mass of the raw material powder from the viewpoint of sufficiently suppressing the occurrence of the mixing unevenness and easily obtaining a homogeneous composite powder. When the addition amount of carboxylic acid solution A is within the above range, it is easy to adjust the entire raw material powder to a moderately wet state. When the addition amount of carboxylic acid solution A is small, it may be difficult for aliphatic carboxylic acid compound A to uniformly spread throughout the raw material powder. When the addition amount of carboxylic acid solution A is large, the raw material powder becomes a slurry state, and a large amount of carboxylic acid solution A and the raw material powder may adhere to the wall surface of the mixing container, and a large amount of aliphatic carboxylic acid compound A may be precipitated on the wall surface of the mixing container during drying (in the step of removing the solvent).

### (Step of Removing Solvent)

In the step of removing the solvent, the raw material powder in the wet state is dried while being stirred to remove the solvent, thereby obtaining a composite powder. The composite powder contains the raw material powder and the aliphatic carboxylic acid compound attached to surfaces of particles of the raw material powder. Drying can be performed by heating, pressure reduction, or the like. When the solvent is ethanol, drying by heating may be performed at a temperature about from 50° C. to 90° C.

When drying by heating is performed, it is preferable to maintain a stirring state until the temperature of the raw material powder falls below the melting point of aliphatic carboxylic acid compound A. If stirring is stopped before the temperature of the raw material powder falls below the melting point of aliphatic carboxylic acid compound A, aliphatic carboxylic acid compound A in a molten state may move to cause the mixing unevenness.

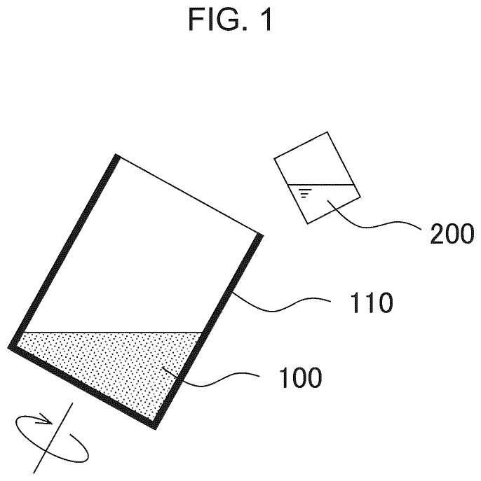

Here, FIG. 1 is a view illustrating an example of wet mixing of a raw material powder and aliphatic carboxylic acid compound A. Raw material powder 100 is accommodated in mixing container 110. Solution 200 of aliphatic carboxylic acid compound A is added to raw material powder 100 while stirring raw material powder 100. In this manner, raw material powder 100 in a wet state is obtained. Thereafter, raw material powder 100 in the wet state placed in mixing container 110 is dried while being stirred to remove a solvent. In this manner, a composite powder is obtained.

### [Method of Manufacturing Anode Body for Electrolytic Capacitor]

A method of manufacturing an anode body for an electrolytic capacitor according to an exemplary embodiment of the present disclosure includes: a step of preparing a composite powder; a step of molding the composite powder; a step of removing aliphatic carboxylic acid compound A; a step of sintering a compact; and a step of forming a dielectric layer.

### (Step of Preparing Composite Powder)

In this step, a composite powder of the present disclosure is prepared. In this step, for example, the composite powder obtained by the above-described manufacturing method is prepared.

### (Step of Molding Composite Powder)

In the step of molding the composite powder, the composite powder is filled in a predetermined mold and compression-molded to obtain a compact. The compact contains aliphatic carboxylic acid compound A. In this step, a part of an anode wire may be embedded in the compact.

FIGS. 2A to 2C are views illustrating an example of a process of producing the compact from the composite powder.

First, as illustrated in FIG. 2A, composite powder 300 is put into weighing hole 420a formed by weighing mold 420 and lower mold 440 and having a constant volume, and weighing hole 420a is filled with composite powder 300 using grinding slider 410. In this manner, composite powder 300 is weighed. At this time, since composite powder 300 containing aliphatic carboxylic acid compound A is excellent in weighing stability, it is possible to stably perform weighing by filling weighing hole 420a with powder 300 using grinding slider 410. That is, variation in an amount of powder filled in weighing hole 420a can be reduced. As a result, variation in mass can be reduced for each of the compact, a porous body, and a sintered body produced in the subsequent steps.

Next, as illustrated in FIG. 2B, weighed composite powder 300 is disposed in predetermined space 460 formed by press mold 430 and lower mold 440. Thereafter, upper mold 450 is disposed above space 460, and anode wire 6 is inserted into a predetermined hole of upper mold 450 to dispose a part of anode wire 6 in space 460.

Next, as illustrated in FIG. 2C, press mold 430 is moved in a direction of an arrow to compression-mold composite powder 300. In this manner, compact 310 in which a part of anode wire 6 is embedded is formed.

### (Step of Removing Aliphatic Carboxylic Acid Compound A)

In the step of removing aliphatic carboxylic acid compound A, aliphatic carboxylic acid compound A included in the compact is removed. For example, aliphatic carboxylic acid compound A included in the compact can be vaporized and removed. More specifically, the removal can be performed, for example, by heating the compact to a predetermined temperature (a temperature more than or equal to a boiling point of aliphatic carboxylic acid compound A) under reduced pressure. When the boiling point of aliphatic carboxylic acid compound A is less than or equal to 400° C., aliphatic carboxylic acid compound A can be removed at a temperature of about 400° C. to 500° C. under reduced pressure. Note that the removing step under reduced pressure may be performed under vacuum or under an atmosphere in which a small amount of inert gas, such as Ar gas, is caused to flow in while performing vacuuming by a vacuum pump.

In a case where a small amount of aliphatic carboxylic acid compound A is added, the weighing stability of the powder can be sufficiently enhanced, and thus, the amount of aliphatic carboxylic acid compound A remaining in the compact without being removed in the removing step can be sufficiently reduced. As a result, a content of carbon derived from aliphatic carboxylic acid compound A in the sintered body obtained in the subsequent step can be sufficiently reduced.

### (Step of Sintering Compact)

In the step of sintering the compact, the compact from which aliphatic carboxylic acid compound A has been removed is sintered to obtain the porous body (sintered body). Details of the porous body will be described later. The compact can be sintered, for example, at a temperature from 1200° C. to 1500° C. under reduced pressure. Note that the sintering step under reduced pressure is preferably performed under high vacuum.

FIG. 3 is a configuration diagram illustrating an example of equipment used in the step of removing aliphatic carboxylic acid compound A and the step of sintering the compact. In FIG. 3, compact A is a compact including aliphatic carboxylic acid compound A, and compact B is a compact obtained after a process of removing aliphatic carboxylic acid compound A.

Equipment 500 includes removal furnace 510 for removing aliphatic carboxylic acid compound A from compact A to obtain compact B, sintering furnace 520 for sintering compact B, recovery tank 530 for recovering aliphatic carboxylic acid compound A removed from compact A, heat insulation pipe 540, and vacuum pump 550. Heat insulation pipe 540 is disposed between removal furnace 510 and recovery tank 530.

The inside of heat insulation pipe 540 is adjusted to a temperature more than or equal to a melting point of aliphatic carboxylic acid compound A. This suppresses precipitation of aliphatic carboxylic acid compound A in pipe 540. For example, when the melting point of aliphatic carboxylic acid compound A is less than or equal to 100° C., the temperature in pipe 540 may be kept at about 120° C. to 150° C. In this case, it is not necessary to provide a pipe having a special heat-insulating structure, which is advantageous in terms of manufacturing cost.

Heat insulation pipe 540 and recovery tank 530 are disposed between removal furnace 510 and vacuum pump 550. The pressure inside each of removal furnace 510, heat insulation pipe 540, and recovery tank 530 is reduced by vacuum pump 550. The pressure inside sintering furnace 520 is also reduced by vacuum pump 550. Recovery tank 530 is cooled with liquid nitrogen or the like, and aliphatic carboxylic acid compound A is solidified and recovered. Note that valves may be provided, respectively, between removal furnace 510 and sintering furnace 520, between removal furnace 510 and heat insulation pipe 540, between heat insulation pipe 540 and recovery tank 530, between recovery tank 530 and vacuum pump 550, and between sintering furnace 520 and vacuum pump 550. The valves may be open and closed according to a place, timing, or the like at which pressure reduction is required.

Hereinafter, the removing step and the sintering step using the equipment of FIG. 3 will be described.

Compact A is supplied to removal furnace 510 under reduced pressure, and aliphatic carboxylic acid compound A is removed from compact A, whereby compact B is produced. Next, the compact B is supplied to sintering furnace 520 under reduced pressure and sintered, whereby the sintered body is produced. On the other hand, aliphatic carboxylic acid compound A removed by evaporation in removal furnace 510 passes through heat insulation pipe 540 and is recovered in recovery tank 530.

Although the removal furnace and the sintering furnace are separately provided in FIG. 3, the single furnace serving as both the removal furnace and the sintering furnace may be provided. That is, the removing step and the sintering step may be performed by the single furnace. One or both of the removal furnace and the sintering furnace may be configured using one furnace or a plurality of furnaces. Further, as for the vacuum pump, a vacuum pump connected to the recovery tank and a vacuum pump connected to the sintering furnace may be separately provided.

### (Step of Forming Dielectric Layer)

In the step of forming the dielectric layer, the dielectric layer is formed on a surface of the porous body to obtain an anode body. The dielectric layer is formed by, for example, an anodizing treatment. Details of the dielectric layer will be described later.

Hereinafter, the electrolytic capacitor will be described in detail.

### [Electrolytic Capacitor]

The electrolytic capacitor includes a capacitor element. The capacitor element includes the anode body and a cathode. The anode body includes the porous body and the dielectric layer covering the surface of the porous body. The cathode is formed so as to cover the dielectric layer. The cathode includes at least a solid electrolyte layer.

The anode body may include a rod-shaped anode wire partially embedded in the porous body. In a case where the porous body is a rectangular parallelepiped, the anode wire is planted from one end surface of the rectangular parallelepiped. The anode wire may contain a valve metal. A part of the anode wire is embedded in the porous body, and the remaining part protrudes from the porous body. The remaining part is connected to an anode lead terminal by welding or the like.

### (Porous Body)

The porous body includes a valve metal. Examples of the valve metal include aluminum (Al), titanium (Ti), tantalum (Ta), niobium (Nb), zirconium (Zr), and hafnium (Hf).

The porous body is a sintered product of a compact of raw material particles (raw material powder) containing the valve metal. The particles may be particles of the valve metal, particles of an alloy containing the valve metal, or particles of a compound containing the valve metal. Only one of these kinds of particles may be used, or two or more thereof may be used in mixture.

The porous body can be obtained by compression-molding the raw material particles into a predetermined shape to obtain the compact and sintering the compact. For example, the compact may be obtained by disposing the anode wire at a predetermined position of a mold, inserting the raw material particles into the mold, and performing compression-molding. The porous body in which a part of the anode wire is embedded may be obtained by sintering the compact. The porous body is usually a rectangular parallelepiped.

### (Dielectric Layer)

The dielectric layer is formed to cover an outer surface of the porous body and inner wall surfaces of pores of the porous body. For example, the dielectric layer is formed by performing an anodizing treatment on the porous body and causing a growth of an oxide film at a surface of the porous body. The anodizing treatment may be performed by immersing the porous body in an anodizing solution and performing anodic oxidation on the surface of the porous body. Alternatively, the porous body may be heated under an atmosphere containing oxygen to oxidize the surface of the porous body.

### (Solid Electrolyte Layer)

The solid electrolyte layer is disposed to cover at least a part of the dielectric layer. The solid electrolyte layer may be filled in the pores of the porous body with the dielectric layer interposed therebetween and be formed on the outer surface of the porous body. The solid electrolyte layer may be a stack of two or more different solid electrolyte layers.

The solid electrolyte layer contains a conductive polymer. The conductive polymer may be a π-conjugated polymer, and examples of the conductive polymer include polypyrrole, polythiophene, polyaniline, and derivatives thereof. These may be used alone or in combination of a plurality of kinds. The conductive polymer may be a copolymer of two or more monomers. Note that a derivative of the conductive polymer means a polymer having the conductive polymer as a basic skeleton. Examples of a derivative of polythiophene include poly(3,4-ethylenedioxythiophene) (PEDOT).

A dopant may be added to the conductive polymer. That is, the solid electrolyte layer may contain the conductive polymer and the dopant. The conductive polymer may be included in the solid electrolyte layer in a state of being doped with the dopant. The dopant can be selected depending on the conductive polymer, and a known dopant may be used. Examples of the dopant include benzenesulfonic acid, alkylbenzenesulfonic acid, naphthalenesulfonic acid, alkylnaphthalenesulfonic, polystyrenesulfonic acid (PSS), and salts thereof. The solid electrolyte layer includes, for example, PEDOT doped with PSS.

The solid electrolyte layer containing the conductive polymer can be formed, for example, by impregnating a porous body (anode body) having a dielectric layer formed on a surface thereof with a first treatment liquid containing a monomer (or oligomer) and then polymerizing the monomer (or oligomer) by electrolytic polymerization or chemical polymerization. In the case of chemical polymerization, the first treatment liquid contains, for example, a monomer (or oligomer), an oxidizing agent, and a solvent (or dispersion medium). Examples of the monomer include 3,4-ethylenedioxythiophene (EDOT) and pyrrole. The first treatment liquid may further contain a dopant.

Alternatively, the solid electrolyte layer may be formed by impregnating a porous body (anode body) having a dielectric layer formed on a surface thereof with a treatment liquid containing a conductive polymer and drying the treatment liquid. The treatment liquid contains, for example, a conductive polymer, a solvent (or a dispersion medium), and a dopant as necessary.

### (Others)

The capacitor element may include a cathode layer covering at least a part of the solid electrolyte layer. The electrolytic capacitor may include an anode lead terminal and a cathode lead terminal, which are electrically connected to the capacitor element, and an outer packaging resin disposed around the capacitor element. The cathode lead terminal is connected to a cathode via a conductive member. The anode lead terminal is connected to an end of the anode wire protruding from the porous body. The shape, size, and the like of the capacitor element are not particularly limited, and the capacitor element may be a known capacitor element or a capacitor element that has a configuration similar to the known capacitor element.

### (Cathode Layer)

The cathode layer may include a carbon layer formed on the solid electrolyte layer and a metal paste layer formed on the carbon layer. The carbon layer may be made of a conductive carbon material such as graphite and a resin. The metal paste layer may be made of metal particles (for example, silver particles) and a resin, and may be made of, for example, a known silver paste.

### (Conductive Member)

The cathode layer is connected to a connecting part of the cathode lead terminal by the conductive member. That is, the cathode layer (cathode) is electrically connected to the cathode lead terminal. The conductive member is made of a material having conductivity. The conductive member may be made of a material containing metal particles (for example, silver particles) and a resin, and may be made of, for example, a known metal paste (for example, silver paste). The conductive member is formed by heating the metal paste. The conductive member may be formed of a plurality of conductive layers of different kinds.

### (Outer Packaging Resin)

The outer packaging resin is disposed around the capacitor element so that the capacitor element is not exposed on a surface of the electrolytic capacitor. Furthermore, the outer packaging resin insulates the anode lead terminal from the cathode lead terminal. As the outer packaging resin, known outer packaging resin used for an electrolytic capacitor may be applied. For example, the outer packaging resin may be formed using an insulating resin material used for sealing the capacitor element. The outer packaging resin may be formed by placing the capacitor element in a mold, introducing an uncured thermosetting resin and a filler into the mold in accordance with a transfer molding method, a compression-molding method, or the like, and then performing curing.

Examples of the outer packaging resin include an epoxy resin, a phenol resin, a silicone resin, a melamine resin, a urea resin, an alkyd resin, polyurethane, polyimide, unsaturated polyester, and the like. The outer packaging resin may contain a substance (such as an inorganic filler) other than the resin.

### (Cathode Lead Terminal)

A part of the cathode lead terminal is exposed from the outer packaging resin, and is used as a cathode external terminal. A material of the cathode lead terminal may be any material that can be used as a material of the cathode lead terminal of the electrolytic capacitor. For example, a known cathode lead terminal material used in an electrolytic capacitor may be used. The cathode lead terminal may be formed by, for example, processing a metal sheet (including a metal plate and a metal foil) made of a metal (copper, a copper alloy, or the like) by a known metal processing method.

### (Anode Lead Terminal)

A part of the anode lead terminal is exposed from the outer packaging resin, and is used as an anode external terminal. A material of the anode lead terminal may be any material that can be used as a material of the anode lead terminal of the electrolytic capacitor. For example, a known anode lead terminal material used for the electrolytic capacitor may be used. The anode lead terminal may be formed by, for example, processing a metal sheet (including a metal plate and a metal foil) made of a metal (copper, a copper alloy, or the like) by a known metal processing method.

FIG. 4 is a cross-sectional view schematically illustrating an example of the electrolytic capacitor according to the present exemplary embodiment. The electrolytic capacitor according to the present embodiment is not limited thereto.

Electrolytic capacitor 20 includes capacitor element 10, outer packaging resin 11 that seals capacitor element 10, and anode lead terminal 12 and cathode lead terminal 13 which are electrically connected to capacitor element 10. A part of anode lead terminal 12 and a part of cathode lead terminal 13 are individually exposed from outer packaging resin 11. A part of anode lead terminal 12 and a part of cathode lead terminal 13 are covered with outer packaging resin 11 together with capacitor element 10.

Capacitor element 10 includes anode body 1, solid electrolyte layer 2 formed on anode body 1, and cathode layer 3 formed on solid electrolyte layer 2. Anode body 1 includes porous body 4 containing a valve metal, and dielectric layer 5 covering porous body 4. Dielectric layer 5 is formed to cover an outer surface of porous body 4 and inner wall surfaces of pores.

Porous body 4 has a substantially rectangular parallelepiped shape and has six side surfaces. A part of anode wire 6 extends from one side surface of porous body 4. That is, anode wire 6 includes first portion 6a embedded in porous body 4 from one side surface of porous body 4, and second portion 6b extending from one side surface of porous body 4. Second portion 6b is joined to anode lead terminal 12 by welding or the like.

Solid electrolyte layer 2 is formed to cover at least a part of dielectric layer 5. Solid electrolyte layer 2 is filled in the pores of porous body 4 (anode body 1). Solid electrolyte layer 2 is formed to cover the outer surface of porous body 4 and the inner wall surfaces of the pores with dielectric layer 5 interposed therebetween.

Cathode layer 3 is formed to cover a surface of solid electrolyte layer 2. Cathode layer 3 includes, for example, carbon layer 3a formed to cover solid electrolyte layer 2 and metal paste layer 3b formed on a surface of carbon layer 3a. Cathode lead terminal 13 is joined to cathode layer 3 (metal paste layer 3b) with conductive member 8 interposed therebetween. Carbon layer 3a contains a conductive carbon material such as graphite and a resin. Metal paste layer 3b contains, for example, metal particles (for example, silver) and a resin. Note that, cathode layer 3 is not limited to this configuration. The configuration of cathode layer 3 may have a current collecting function.

### <<Note>>

The above description of the exemplary embodiments discloses the following technologies.

### (Technology 1)

A composite powder for manufacturing a porous body included in an anode body of an electrolytic capacitor, the composite powder including:
a raw material powder containing a valve metal; and
an aliphatic carboxylic acid compound adhering to a surface of a particle of the raw material powder, the aliphatic carboxylic acid compound excluding stearic acid, palmitic acid, and a polymer,
wherein a melting point of the aliphatic carboxylic acid compound is more than or equal to 35° C.

### (Technology 2)

The composite powder according to Technology 1, wherein the melting point of the aliphatic carboxylic acid compound is more than or equal to 35° C. and less than or equal to 120° C.

### (Technology 3)

The composite powder according to Technology 1 or 2, wherein a boiling point of the aliphatic carboxylic acid compound is less than or equal to 400° C.

### (Technology 4)

The composite powder according to any one of Technologies 1 to 3, wherein a degree of solubility of the aliphatic carboxylic acid compound in 100 g of a solvent at 20° C. is more than or equal to 20 g, and the solvent is ethanol, isopropanol, or butyl acetate.

### (Technology 5)

The composite powder according to any one of Technologies 1 to 4, wherein the aliphatic carboxylic acid compound contains at least one selected from the group consisting of lauric acid, tridecylic acid, myristic acid, and pentadecylic acid.

### (Technology 6)

The composite powder according to any one of Technologies 1 to 5, wherein the aliphatic carboxylic acid compound contains at least one selected from the group consisting of crotonic acid, elaidic acid, bacenic acid, nervonic acid, eleostearic acid, and glutaric acid.

### (Technology 7)

The composite powder according to any one of Technologies 1 to 6, wherein a content of the aliphatic carboxylic acid compound in the composite powder is more than or equal to 0.002 parts by mass and less than or equal to 0.1 parts by mass with respect to 100 parts by mass of the raw material powder.

### (Technology 8)

The composite powder according to any one of Technologies 1 to 7, wherein the anode body includes the porous body containing the valve metal and a dielectric layer covering a surface of the porous body.

### (Technology 9)

A method of manufacturing a composite powder for manufacturing a porous body included in an anode body of an electrolytic capacitor, the method including:
a step of preparing a raw material powder containing a valve metal;
a step of preparing a carboxylic acid solution containing a solvent and an aliphatic carboxylic acid compound having a melting point of more than or equal to 35° C., the aliphatic carboxylic acid compound excluding stearic acid, palmitic acid, and a polymer;
a step of adding the carboxylic acid solution to the raw material powder while stirring the raw material powder to obtain the raw material powder in a wet state; and
a step of removing the solvent by drying the raw material powder in the wet state while stirring the raw material powder to obtain a composite powder,
wherein the composite powder contains the raw material powder and the aliphatic carboxylic acid compound adhering to a surface of a particle of the raw material powder.

### (Technology 10)

The method according to Technology 9, wherein the melting point of the aliphatic carboxylic acid compound is more than or equal to 35° C. and less than or equal to 120° C.

### (Technology 11)

The method according to Technology 9 or 10, wherein a boiling point of the aliphatic carboxylic acid compound is less than or equal to 400° C.

### (Technology 12)

The method according to any one of Technologies 9 to 11, wherein the aliphatic carboxylic acid compound contains at least one selected from the group consisting of lauric acid, tridecylic acid, myristic acid, and pentadecylic acid.

### (Technology 13)

The method according to any one of Technologies 9 to 12, wherein the aliphatic carboxylic acid compound contains at least one selected from the group consisting of crotonic acid, elaidic acid, bacenic acid, nervonic acid, eleostearic acid, and glutaric acid.

### (Technology 14)

The method according to any one of Technologies 9 to 13, wherein a content of the aliphatic carboxylic acid compound in the composite powder is more than or equal to 0.002 parts by mass and less than or equal to 0.1 parts by mass with respect to 100 parts by mass of the raw material powder.

### (Technology 15)

The method according to any one of Technologies 9 to 14, wherein an amount of the carboxylic acid solution added to the raw material powder is more than or equal to 5 parts by mass and less than or equal to 20 parts by mass with respect to 100 parts by mass of the raw material powder.

### (Technology 16)

The method according to any one of Technologies 9 to 15, wherein the solvent contains at least one selected from the group consisting of ethanol, isopropanol, and butyl acetate.

### (Technology 17)

The method according to any one of Technologies 9 to 16, wherein the anode body includes the porous body containing the valve metal and a dielectric layer covering a surface of the porous body.

### (Technology 18)

A method of manufacturing an anode body for an electrolytic capacitor, the method including:
a step of preparing a composite powder containing a raw material powder containing a valve metal and an aliphatic carboxylic acid compound adhering to a surface of a particle of the raw material powder, the aliphatic carboxylic acid compound excluding stearic acid, palmitic acid, and a polymer;
a step of performing compression-molding after filling a predetermined mold with the composite powder to obtain a compact;
a step of removing the aliphatic carboxylic acid compound included in the compact;
a step of sintering the compact from which the aliphatic carboxylic acid compound has been removed to obtain a porous body; and
a step of forming a dielectric layer on a surface of the porous body to obtain an anode body,
wherein a melting point of the aliphatic carboxylic acid compound is more than or equal to 35° C.

### (Technology 19)

The method according to Technology 18, wherein the melting point of the aliphatic carboxylic acid compound is more than or equal to 35° C. and less than or equal to 120° C.

### (Technology 20)

The method according to Technology 18 or 19, wherein a boiling point of the aliphatic carboxylic acid compound is less than or equal to 400° C.

### (Technology 21)

The method according to any one of Technologies 18 to 20, wherein the aliphatic carboxylic acid compound contains at least one selected from the group consisting of lauric acid, tridecylic acid, myristic acid, and pentadecylic acid.

### (Technology 22)

The method according to any one of Technologies 18 to 21, wherein the aliphatic carboxylic acid compound contains at least one selected from the group consisting of crotonic acid, elaidic acid, bacenic acid, nervonic acid, eleostearic acid, and glutaric acid.

### (Technology 23)

The method according to any one of Technologies 18 to 22, wherein a content of the aliphatic carboxylic acid compound in the composite powder is more than or equal to 0.002 parts by mass and less than or equal to 0.1 parts by mass with respect to 100 parts by mass of the raw material powder.

### EXAMPLES

Although the present disclosure will be specifically described below based on Examples and Comparative Examples, the present disclosure is not limited to Examples below.

### Examples 1 to 10

### (Production of Composite Powder)

As a raw material powder, Ta powder (average particle size: 80 μm, CV value: 70 kCV) was prepared. As an additive solution, a carboxylic acid solution containing aliphatic carboxylic acid compound A (additive) and ethanol (solvent) was prepared. As aliphatic carboxylic acid compound A, myristic acid or lauric acid was used. Both of myristic acid and lauric acid have a melting point in the range from 35° C. to 120° C., a boiling point of less than or equal to 400° C., and a degree of solubility in 100 g of ethanol of more than or equal to 20 g.

The carboxylic acid solution was added to the raw material powder while stirring the raw material powder to obtain the raw material powder in a wet state (FIG. 1). An addition amount of aliphatic carboxylic acid compound A was set to values (parts by mass) shown in Table 1 with respect to 100 parts by mass of the raw material powder. In addition, the concentration of the carboxylic acid solution was appropriately adjusted so as to set the addition amount of the carboxylic acid solution within the range of 5 to 20 parts by mass with respect to 100 parts by mass of the raw material powder.

The raw material powder in the wet state was heated at a temperature of less than or equal to 90° C. to be dried while being stirred to remove the solvent. In this manner, a composite powder (Ta particles having the aliphatic carboxylic acid compound adhering to surfaces: composite particles) containing the raw material powder and the aliphatic carboxylic acid compound adhering to the surfaces of particles of the raw material powder was obtained.

### (Production of Compact)

A predetermined mold was filled with a predetermined amount of the composite powder by grinding and weighing (FIG. 2A). One end of an anode wire was embedded in a portion filled with the composite powder (FIG. 2B). Thereafter, the composite powder was compression-molded to obtain a compact (FIG. 2C). An outer shape of the compact was a rectangular parallelepiped (0.8 mm×3.7 mm×5.2 mm). A Ta wire was used as the anode wire.

### (Production of Sintered Body)

The aliphatic carboxylic acid compound included in the compact was removed under reduced pressure at a temperature from 400° C. to 500° C.

Next, the compact from which the aliphatic carboxylic acid compound had been removed was sintered under reduced pressure at a temperature from 1300° C. to 1400° C. At this time, a sintering temperature and a sintering time were adjusted such that a shrinkage rate was about 10%. In this manner, a porous body (Ta sintered body) in which a part of the anode wire was embedded was obtained.

### Comparative Example 1

As an additive solution, an acrylic resin solution (solvent:toluene) was prepared instead of a carboxylic acid solution. An addition amount of an acrylic resin was 1.5 parts by mass with respect to 100 parts by mass of a raw material powder. Except for the above, each of a composite powder, a compact, and a sintered body was produced in the same manner as in Example 1.

### Comparative Example 2

As an additive solution, a camphor solution (solvent:methanol) was prepared instead of a carboxylic acid solution. An addition amount of camphor was 1.5 parts by mass with respect to 100 parts by mass of a raw material powder. Except for the above, each of a composite powder, a compact, and a sintered body was produced in the same manner as in Example 1.

### Comparative Example 3

As an additive solution, a stearic acid solution (solvent:ethanol) was prepared instead of a carboxylic acid solution. An addition amount of stearic acid was 0.01 parts by mass with respect to 100 parts by mass of a raw material powder. A composite powder was produced in the same manner as in Example 1 except for the above.

### Comparative Example 4

No additive was used. That is, each of a compact and a sintered body was produced in the same manner as in Example 1 except that a raw material powder was used instead of a composite powder.

The compacts and sintered bodies produced in the above Examples and Comparative Examples were evaluated as follows.

### [Evaluation]

### (Non-Defective Product Rate of Compacts)

In order to evaluate the weighing stability of the powder, a non-defective product rate of compacts was obtained. Specifically, 300 compacts were produced using an automatic molding machine, and the mass of each of the 300 compacts was measured. Among the 300 compacts, a proportion of the number of compacts whose mass was within ±0.5% of the target mass (non-defective products) was obtained as a non-defective product rate of the compacts. When a powder has high weighing stability, variation in mass of the compacts is reduced, and the non-defective product rate of the compacts increases.

### (Crack (Chipping) Occurrence Rate of Compacts)

100 compacts were randomly extracted from the compacts produced as above. A proportion of the number of compacts in which a crack (chipping) occurred among the 100 compacts was obtained as a crack (chipping) occurrence rate (%).

### (Carbon Content of Sintered Body)

A carbon content (ppm by mass) of a sintered body was obtained using about 1 g of the sintered body. As a measuring device, a carbon and sulfur analyzer (manufactured by HORIBA, Ltd.) was used.

### (LC in Liquid)

A sintered body in which a part of an anode wire was embedded was subjected to an anodizing treatment (anodization). The anodizing treatment was performed in a 0.02% by mass phosphoric acid aqueous solution at an anodizing voltage of 80 V and a temperature of 60° C. A predetermined voltage of less than 80 V was applied to the sintered body (anode body) after the anodizing treatment in the phosphoric acid aqueous solution, and a current value at a time point when a predetermined time had elapsed from the start of the application of the voltage was obtained as a leakage current (LC) in liquid.

### (Coefficient of Variation Representing Variation in Amount of Powder Filled in Weighing Hole)

For the composite powders of Examples 4 and 9 and Comparative Example 3, a coefficient of variation representing variation in an amount of powder filled in a weighing hole was obtained. In Comparative Example 4, a coefficient of variation was obtained for the raw material powder in the same manner. Weighing stability was evaluated based on the coefficient of variation.

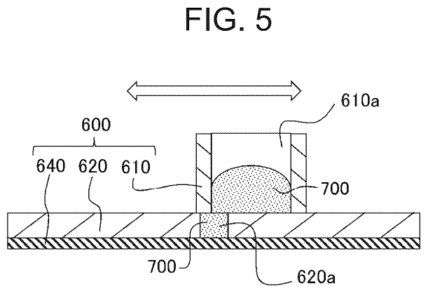

The weighing stability was evaluated using an evaluation jig set illustrated in FIG. 5. Note that evaluation jig set 600 of FIG. 5 includes filling jig 610, weighing jig 620, and metal plate 640, and is configured assuming filling of weighing hole 420a with composite powder 300 using grinding slider 410 of FIG. 2A.

Specifically, filling jig 610 that is made of stainless steel and has a hollow cylindrical shape (inner diameter: 20 mm), weighing jig 620 that is made of stainless steel and has a plate shape (thickness: 4 mm) in which weighing hole 620a (diameter: 3 mm) having a circular cross-sectional shape is formed at the center, and metal plate 640 were prepared. As illustrated in FIG. 5, weighing jig 620 was disposed on metal plate 640, and filling jig 610 was disposed on weighing jig 620. Powder 700 in an amount of 2 g was put into hollow portion 610a of filling jig 610, and filling jig 610 was caused to reciprocate three times (in a direction of an arrow illustrated in FIG. 5) so as to pass through weighing hole 620a of weighing jig 620. In this manner, weighing hole 620a was filled with powder 700. Next, powder 700 filled in weighing hole 620a was taken out, and the mass thereof was measured. Such measurement was repeated ten times. A standard deviation and an average value of ten measured values were obtained. As a coefficient of variation (%) representing variation in an amount of powder 700 filled in weighing hole 620a, (standard deviation/average value)×100 was obtained. A case where the coefficient of variation is small represents that the variation in the filling amount of the powder is small.

Table 1 show evaluation results. An addition amount of an additive in Table 1 represents an amount with respect to 100 parts by mass of a raw material powder.

TABLE 1

| | | | | Coefficient of | Non- | Crack | Carbon | |
|---|---|---|---|---|---|---|---|---|
| | | | Addition | variation representing | defective | (chipping) | content of | LC in |
| | | | amount of | variation in amount of | product | occurrence | sintered | liquid of |
| | | | additive | powder filled in | rate of | rate of | body | sintered |
| | Additive solution | | (parts by | weighing hole | compacts | compacts | (ppm by | body |
| | Additive | Solvent | mass) | (%) | (%) | (%) | mass) | (μA) |
| Example 1 | Myristic acid | Ethanol | 0.001 | — | 66 | 0 | 52 | 5.9 |
| Example 2 | Myristic acid | Ethanol | 0.002 | — | 90 | 0 | 53 | 6.5 |
| Example 3 | Myristic acid | Ethanol | 0.005 | — | 99 | 0 | 53 | 8.7 |
| Example 4 | Myristic acid | Ethanol | 0.01 | 5 | 99 | 0 | 65 | 9.6 |
| Example 5 | Myristic acid | Ethanol | 0.02 | — | 98 | 0 | 85 | 10.2 |
| Example 6 | Myristic acid | Ethanol | 0.05 | — | 99 | 0 | 131 | 11.3 |
| Example 7 | Myristic acid | Ethanol | 0.1 | — | 98 | 0 | 149 | 13.2 |
| Example 8 | Myristic acid | Ethanol | 0.2 | — | 98 | 3 | 178 | 17.5 |
| Example 9 | Lauric acid | Ethanol | 0.01 | 8 | 97 | 0 | 53 | 10.2 |
| Example 10 | Lauric acid | Ethanol | 0.1 | — | 98 | 0 | 50 | 9.3 |
| Comparative | Acrylic resin | Toluene | 1.5 | — | 99 | — | 223 | 42.1 |
| Example 1 | | | | | | | | |
| Comparative | Camphor | Methanol | 1.5 | — | 45 | — | 48 | 10.4 |
| Example 2 | | | | | | | | |
| Comparative | Stearic acid | Ethanol | 0.01 | 10 | — | — | — | — |
| Example 3 | | | | | | | | |
| Comparative | None | — | — | 15 | 55 | — | 49 | 10.1 |
| Example 4 | | | | | | | | |

In Examples 1 to 10, the non-defective product rate of compacts was high, good weighing stability was obtained for the composite powder, the carbon content of the sintered body was reduced, and the LC in liquid was reduced. When the addition amount of the aliphatic carboxylic acid compound was less than or equal to 0.1 parts by mass, no crack (chipping) of the compact was observed (Examples 1 to 7 and 9). When the addition amount of the aliphatic carboxylic acid compound was more than or equal to 0.002 parts by mass, the non-defective product rate of the compacts was higher, and the weighing stability was further improved (Examples 2 to 10).

In Comparative Example 1 in which the additive was the acrylic resin, it was necessary to add a large amount to secure the weighing stability, the carbon content increased, and the LC in the liquid increased. In Comparative Example 2 in which camphor was added to a Ta powder having an average particle size of less than 100 μm, the weighing stability was reduced, and a yield of molding was reduced.

In Comparative Example 3 in which stearic acid was used as the additive, the coefficient of variation representing the variation in the filling amount of the powder was smaller than that in Comparative Example 4 in which no additive was added, but the coefficient of variation was larger than those in Examples 4 and 9 in which aliphatic carboxylic acid compound A was used as the additive. In a case where the additive was stearic acid, a degree of solubility in ethanol or the like was low, and it took time to prepare the stearic acid solution containing ethanol or the like. In addition, when the stearic acid solution containing ethanol or the like was added to the raw material powder placed in a mixing container and wet mixing was performed, stearic acid was precipitated on a wall surface of the mixing container, and mixing unevenness occurred. In a case where the additive was palmitic acid, the mixing unevenness occurred similarly.

A composite powder according to the present disclosure is suitably used for manufacturing a porous body included in an anode body of an electrolytic capacitor.

What is claimed is:

1. A composite powder for manufacturing a porous body included in an anode body of an electrolytic capacitor, the composite powder comprising:
a raw material powder containing a valve metal; and
an aliphatic carboxylic acid compound adhering to a surface of a particle of the raw material powder, the aliphatic carboxylic acid compound excluding stearic acid, palmitic acid, and a polymer,
wherein a melting point of the aliphatic carboxylic acid compound is more than or equal to 35° C.

2. The composite powder according to claim 1, wherein the melting point of the aliphatic carboxylic acid compound is more than or equal to 35° C. and less than or equal to 120° C.

3. The composite powder according to claim 1, wherein a boiling point of the aliphatic carboxylic acid compound is less than or equal to 400° C.

4. The composite powder according to claim 1, wherein:
a degree of solubility of the aliphatic carboxylic acid compound in 100 g of a solvent at 20° C. is more than or equal to 20 g, and
the solvent is ethanol, isopropanol, or butyl acetate.

5. The composite powder according to claim 1, wherein the aliphatic carboxylic acid compound contains at least one selected from the group consisting of lauric acid, tridecylic acid, myristic acid, and pentadecylic acid.

6. The composite powder according to claim 1, wherein the aliphatic carboxylic acid compound contains at least one selected from the group consisting of crotonic acid, elaidic acid, bacenic acid, nervonic acid, eleostearic acid, and glutaric acid.

7. The composite powder according to claim 1, wherein a content of the aliphatic carboxylic acid compound in the composite powder is more than or equal to 0.002 parts by mass and less than or equal to 0.1 parts by mass with respect to 100 parts by mass of the raw material powder.

8. The composite powder according to claim 1, wherein the anode body includes the porous body containing the valve metal and a dielectric layer covering a surface of the porous body.

9. A method of manufacturing a composite powder for manufacturing a porous body included in an anode body of an electrolytic capacitor, the method comprising:
preparing a raw material powder containing a valve metal;
preparing a carboxylic acid solution containing a solvent and an aliphatic carboxylic acid compound having a melting point of more than or equal to 35° C., the aliphatic carboxylic acid compound excluding stearic acid, palmitic acid, and a polymer;
adding the carboxylic acid solution to the raw material powder while stirring the raw material powder to obtain the raw material powder in a wet state; and
removing the solvent by drying the raw material powder in the wet state while stirring the raw material powder to obtain a composite powder,
wherein the composite powder contains the raw material powder and the aliphatic carboxylic acid compound adhering to a surface of a particle of the raw material powder.

10. The method according to claim 9, wherein the melting point of the aliphatic carboxylic acid compound is more than or equal to 35° C. and less than or equal to 120° C.

11. The method according to claim 9, wherein a boiling point of the aliphatic carboxylic acid compound is less than or equal to 400° C.

12. The method according to claim 9, wherein the aliphatic carboxylic acid compound contains at least one selected from the group consisting of lauric acid, tridecylic acid, myristic acid, and pentadecylic acid.

13. The method according to claim 9, wherein the aliphatic carboxylic acid compound contains at least one selected from the group consisting of crotonic acid, elaidic acid, bacenic acid, nervonic acid, eleostearic acid, and glutaric acid.

14. The method according to claim 9, wherein a content of the aliphatic carboxylic acid compound in the composite powder is more than or equal to 0.002 parts by mass and less than or equal to 0.1 parts by mass with respect to 100 parts by mass of the raw material powder.

15. The method according to claim 9, wherein an amount of the carboxylic acid solution added to the raw material powder is more than or equal to 5 parts by mass and less than or equal to 20 parts by mass with respect to 100 parts by mass of the raw material powder.

16. The method according to claim 9, wherein the solvent contains at least one selected from the group consisting of ethanol, isopropanol, and butyl acetate.

17. The method according to claim 9, wherein the anode body includes the porous body containing the valve metal and a dielectric layer covering a surface of the porous body.

18. A method of manufacturing an anode body for an electrolytic capacitor, the method comprising:
preparing a composite powder containing a raw material powder containing a valve metal and an aliphatic carboxylic acid compound adhering to a surface of a particle of the raw material powder, the aliphatic carboxylic acid compound excluding stearic acid, palmitic acid, and a polymer;
performing compression-molding after filling a predetermined mold with the composite powder to obtain a compact;
removing the aliphatic carboxylic acid compound included in the compact;
sintering the compact from which the aliphatic carboxylic acid compound has been removed to obtain a porous body; and
forming a dielectric layer on a surface of the porous body to obtain an anode body,
wherein a melting point of the aliphatic carboxylic acid compound is more than or equal to 35° C.

19. The method according to claim 18, wherein the melting point of the aliphatic carboxylic acid compound is more than or equal to 35° C. and less than or equal to 120° C.

20. The method according to claim 18, wherein a boiling point of the aliphatic carboxylic acid compound is less than or equal to 400° C.

21. The method according to claim 18, wherein the aliphatic carboxylic acid compound contains at least one selected from the group consisting of lauric acid, tridecylic acid, myristic acid, and pentadecylic acid.

22. The method according to claim 18, wherein the aliphatic carboxylic acid compound contains at least one selected from the group consisting of crotonic acid, elaidic acid, bacenic acid, nervonic acid, eleostearic acid, and glutaric acid.

23. The method according to claim 18, wherein a content of the aliphatic carboxylic acid compound in the composite powder is more than or equal to 0.002 parts by mass and less than or equal to 0.1 parts by mass with respect to 100 parts by mass of the raw material powder.
